(19) United States
(12) Patent Application Publication
(10) Pub. No.: US 2017/0214110 A1
(43) Pub. Date: Jul. 27, 2017

(54) DIELECTRIC LOADED ANTENNA FOR HIGH TEMPERATURE ENVIRONMENT

(71) Applicant: BAE Systems plc, London (GB)

(72) Inventors: David John SHEPARD, Essex (GB); Barbara Helen WRIGHT, Essex (GB)

(21) Appl. No.: 15/329,679

(22) PCT Filed: Jul. 28, 2015
(86) PCT No.: PCT/GB2015/052173

§ 371 Date: Jan. 27, 2017

(30) Foreign Application Priority Data
Aug. 1, 2014 (GB) 1413688.1

(51) Int. Cl. H01Q 1/00; H01Q 13/06; H01Q 1/40; H01Q 1/28

(52) U.S. Cl. CPC H01Q 1/002; H01Q 1/28; H01Q 13/06; H01Q 1/40

(57) ABSTRACT

A dielectric loaded antenna, and method of designing same, for use in a high temperature environment, the antenna comprising an outer casing (14) of a material having a melting point of at least 1000° C., said outer casing (14) defining an inner channel, a first end of the channel defined by the casing defining a radiating aperture loaded with a section (Z4) of dielectric material of a first type which is chemically stable at a temperature of at least 1500° C., and a remaining length of said channel being loaded with sections (ZO-Z3) of at least one second type of dielectric material which is chemically stable at a temperature of at least 800° C., the dielectric constant of said first type of dielectric material being greater than that of the second type of dielectric material.

### FIELD OF THE INVENTION

This invention relates to an antenna and, more particularly, but not necessarily exclusively, to an antenna and method of designing an antenna for use in a system for performing engine health diagnostics using radar.

### BACKGROUND

Two main causes of turbo machinery failure are blade vibration and disk cracks. To achieve the high levels of performance required of modern aircraft, blade and disk designs attempt to achieve high operating stress levels while at the same time minimising size and weight. The complexity of blade shapes, corrosive environments, high-speed operation, and severe thermal and dynamic loads all contribute to blade degradation over time. Blade and disk problems are very difficult to detect with typical on-board sensors such as shaft proximity probes and case mounted vibration sensors, since these problems do not translate to measurable disturbances.

Due to the high cost of in-service failures of aircraft engine components and difficulty of installing on-engine sensors capable of detecting blade problems, visual inspections of aircraft engine components are required at conservative intervals as a preventative measure. Maintenance inspections are costly due to the manpower and equipment required to perform the inspections and also in lost revenue when assets are taken out of service.

Referring to FIG. 1 of the drawings, there is illustrated, as an example only, a schematic cross-sectional view of a typical gas turbine engine, having a front end coupled to an air intake 100, a compressor 102, combustion chambers 104, a turbine 106, and an exhaust 108. The engine casing is typically manufactured from a nickel based alloy. High pressure cooling air is ducted around the casing and blades to prevent them from melting. An abrasive seal is often fitted to the casing around the blades to ensure minimum clearances and improved performance. Other turbine designs will be known to a person skilled in the art, and the present invention is in no way intended to be limited in this regard.

Systems have been proposed that can monitor blade health at the front stages of the engine, but few which can monitor the higher compressors and turbine stages, due to the high temperatures involved. It would therefore be desirable to provide an antenna, and a method of designing an antenna, which can withstand the high temperatures of the later stages of a jet engine.

### SUMMARY OF THE INVENTION

In accordance with an aspect of the present invention, there is provided a dielectric loaded antenna for use in a high temperature environment, the antenna comprising an outer casing of a material having a melting point of at least 1000° C., said outer casing defining an inner channel, a first end of the channel defined by the casing defining a radiating aperture loaded with a section of dielectric material of a first type which is chemically stable at a temperature of at least 1500° C., and a remaining length of said channel being loaded with sections of at least one second type of dielectric material which is chemically stable at a temperature of at least 800° C., the dielectric constant of said first type of dielectric material being greater than that of the second type of dielectric material.

The material of said outer casing may comprise one or more of titanium, nickel alloy, stainless steel, and platinum. The first and second types of dielectric materials may be selected from boron nitride, synthetic sapphire, fused silica, macor and quartzel rigid silica.

In one exemplary embodiment, the first type of dielectric material may comprise synthetic sapphire and the second type of dielectric material may comprise fused silica.

In another exemplary embodiment of the present invention, the first type of dielectric material may comprise synthetic sapphire and the second type of dielectric material may comprise boron nitride.

In yet another exemplary embodiment, the first type of dielectric material may comprise synthetic sapphire and the second type of dielectric material may comprise quartz.

The antenna may comprise a plurality of alternating sections of said first and second types of dielectric material, and in particular each section may adjoin the next to substantially prevent spaces therebetween.

The outer casing may be substantially cylindrical and said channel may comprise a generally central bore through its axial length.

Another aspect of the present invention extends to a sensor for use in a high temperature environment, comprising an antenna as defined above, and a waveguide coupled to said channel.

The waveguide may be coupled to a second end of said channel. Alternatively, the waveguide may be coupled to said channel via a longitudinal slot provided in a side wall of said outer casing.

Yet another aspect of the present invention extends to a method of manufacturing a dielectric loaded antenna for use in a high temperature environment, the method comprising the steps of providing an outer casing of a material having a melting point of at least 1000° C., said outer casing defining a channel, loading a first end of said channel with a section of dielectric material of a first type which is chemically stable at a temperature of at least 1500° C., impedance matching a remaining length of said channel by inserting therein sections of at least one second type of dielectric material which is chemically stable at a temperature of at least 800° C., wherein the dielectric constant of said first type of dielectric material is greater than that of said second type of dielectric material.

Once again the material of said outer casing may comprise one or more of titanium, nickel alloy, stainless steel, and platinum and/or the first and second types of dielectric material may be selected from boron nitride, synthetic sapphire, fused silica, macor and quartzel rigid silica.

### BRIEF DESCRIPTION OF THE DRAWINGS

Embodiments of the present invention will now be described, by way of examples only, and with reference to the accompanying drawings, in which:

FIG. 1 is a schematic cross-sectional diagram illustrating a gas turbine according to an exemplary embodiment of the prior art;

FIG. 2 is a schematic cross-section of a circular dielectric loaded antenna according to an exemplary embodiment of the present invention;

FIG. 3 is a schematic cross-sectional view illustrating the mounting position of an antenna within a turbine assembly;

FIG. 4 is a schematic cross-sectional view of a circular dielectric loaded antenna according to another exemplary embodiment of the present invention;

FIG. 5 is a schematic cross-sectional view of a circular dielectric loaded antenna according to yet another exemplary embodiment of the present invention;

FIG. 5a is a schematic isometric of the sensor of FIG. 5;

FIG. 5b is a schematic side cross-sectional view of the sensor of FIG. 5;

FIG. 6 illustrates the return loss of an antenna according to an exemplary embodiment of the present invention, having a diameter of 7.2 mm;

FIG. 7 is a schematic cross-sectional view of a circular dielectric loaded antenna according to yet another exemplary embodiment of the present invention;

FIG. 8 is a schematic isometric view of a circular dielectric loaded antenna according to yet another exemplary embodiment of the present invention; and

FIG. 8a is a schematic isometric view of the outer casing of the sensor of FIG. 8.

### DETAILED DESCRIPTION

It is known to use dielectric loading in order to miniaturise an antenna design, or otherwise control its geometry within the operating parameter constraints dictated by the application in which it is to be used. In other words, dielectric loading of an antenna is used to enable an antenna of required dimensions to be designed to operate at the desired frequency.

In a sensor according to an exemplary embodiment of the invention, there is provided an outer casing of a metal material the core of which is loaded with layers of dielectric materials, selected in terms of their dielectric constant and thickness in order to effect impedance matching at each interface, with the aim of optimising power transfer through the antenna.

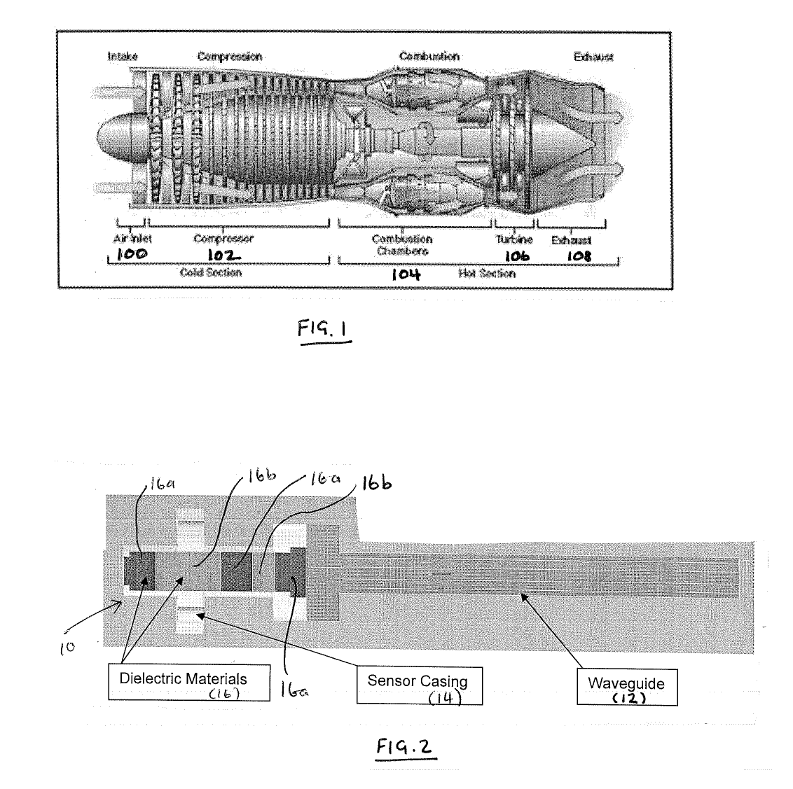

Thus, referring to FIG. 2 of the drawings, a sensor 10 according to an exemplary embodiment of the present invention is required to be connected via a waveguide 12 to a region of, say, a turbine assembly where the environment is cool enough to fit coaxial cable to a processor module. The sensor 10 comprises and outer casing 14 formed of a conductive material, such as metal, and layers of dielectric material 16. In the example shown, the outer casing 14 is substantially cylindrical and substantially axially symmetrical about its longitudinal axis (which is also the general axis of propagation of signals through the sensor 10).

In a first exemplary embodiment, the dielectric material 16 comprises two different dielectric materials 16a, 16b, which alternate along the length of the antenna, from the input/output to the waveguide. The different dielectric materials 16a, 16b are laid up on one another so that one layer adjoins the next, thereby substantially preventing spaces (e.g. airgaps) between layers. Consequently an integral structural formed from dielectric materials is provided. The profile of the inner surface of the casing 14 defines three different diameters: a first diameter adjacent to the waveguide 12, a second diameter, smaller than the first diameter and extending along most of the remaining length of the casing 14, and a third diameter, smaller than the second diameter, and defining the tip of the antenna at the end which extends into the engine casing during use.

If the sensor 10 is to be used in the later stages of the turbine, it is required to withstand relatively high temperatures and pressure. The table below gives parameters of a typical operating environment found in an engine turbine:

| | | | | |
|---|---|---|---|---|
| Turbine gas | >1500° | C. | >2700° | F. |
| temperature | | | | |
| Turbine gas pressure | 40 | bar | 580 | psi |
| Turbine cooling air | 700° | C. | 1300° | F. |
| temperature | | | | |
| Turbine cooling air | 45 | bar | 650 | psi |
| pressure | | | | |

| | |
|---|---|
| Turbine gas content | CO₂, H₂O, NO₂, CO |

| | | |
|---|---|---|
| Vibration | 40 | g max |

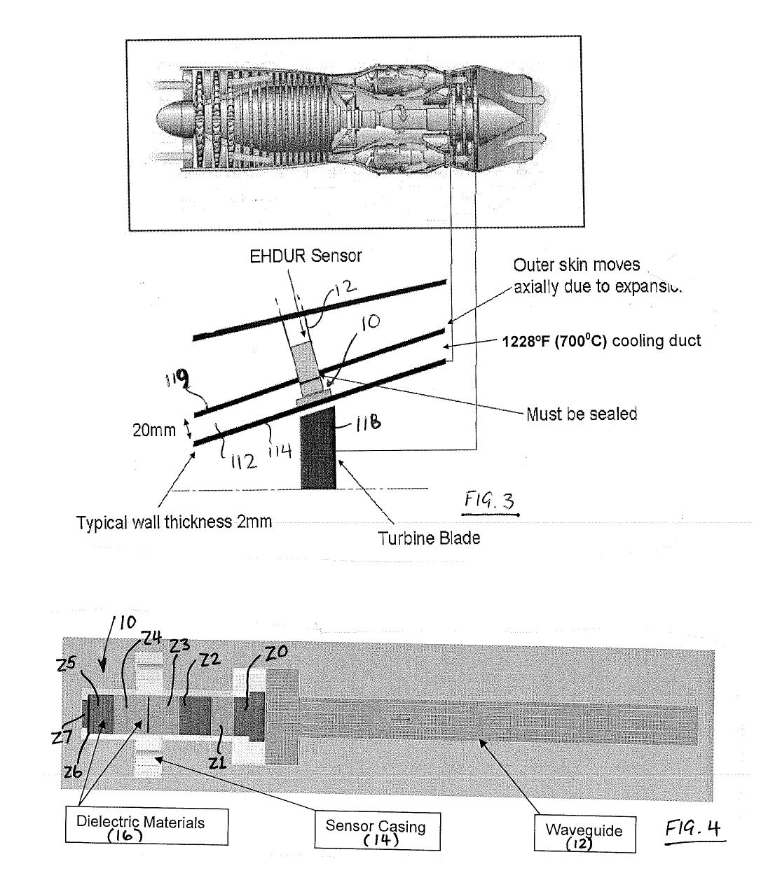

The turbine walls require cooling to ensure that they do not melt at the extreme temperatures present in the turbine. Referring to FIG. 3 of the drawings, cooling air is often guided through an annular duct 112 (typically 20 mm radius) around the inner turbine wall 114. The cooling air may still be at 700° C. (1300° F.) and will be at greater pressure than the turbine gases so that it can be forced through cooling holes in the turbine wall 114. Due to large temperature differentials across different parts of the engine, thermal expansion is a serious issue. When operating, the turbine blades 118 move axially relative to the housings, so any sensor would be required to calibrate the resultant bias out. More significantly, the outer wall 119 of the cooling duct 112 moves a few millimetres relative to the turbine housing wall 114. This level of movement precludes the sensor bridging both walls of the duct 112. Instead, the sensor 10 should be small enough to fit completely inside the cooling duct 112, as shown in FIG. 3. The depth of a typical cooling duct is only 20 mm. The waveguide 12 may then need to exit along the cooling duct 112 and through the forward stationary fin of the turbine assembly. The turbine blades on a large civil aircraft engine are also typically fitted with a continuous rotating shroud around their outer circumference which may influence the mounting location (and, therefore, possibly the size of the sensor).

Thus, the size and dimensions of the sensor are determined primarily by the location within the turbine assembly in which it is to be mounted and used. Furthermore, the sensor requires two main types of material: a dielectric and the outer casing which is electrically conductive. These materials need to be able to withstand the operating environment described above in relation to the engine turbine stage of the assembly and offer the required performance.

A known technique for reducing the diameter of a sensor is dielectric loading with a higher permittivity. Reducing the diameter of the radiating aperture reduces the attainable bandwidth in accordance with Chu's criterion, which relates the Q factor of an antenna to the radius of the minimum sphere which encloses it. The antenna behaves like a damped resonant circuit and the Q-factor determines the bandwidth over which this circuit can be impedance-matched to a transmission line.

The Chu criterion also applies to an aperture in a conducting ground plane, such as sensors for use in engine health monitoring systems for turbine assemblies. For small antennas, the Q-factor increases as the inverse cube of the radius, so a reduction in the diameter of the aperture from, say 11.2 mm to 7.2 mm will reduce the bandwidth by a factor of approximately 0.26. Thus, to keep the overall dimensions as small as possible, the radius of the waveguide behind the aperture is made equal to or only slightly larger than that of the aperture. In order to achieve propagation, the waveguide must be loaded with a dielectric of a suitable permittivity and suitable dimensions, a concept which will be familiar to a person skilled in the art.

A number of high temperature dielectrics have been identified by the inventors which are suitable for use in an antenna according to various exemplary embodiments of the present invention. For example, such dielectrics may be based on silica (SiO₂) and sapphire (Al₂O₃). Amorphous forms of silica are fused quartz and glass; the crystalline form is quartz. Boron nitride is another option. Data for these dielectrics is given below:

| | | | | | Thermal | |
|---|---|---|---|---|---|---|
| | Max | Dielectric | Loss | CTE | Conductivity | |
| Material | Temperature | Constant | Tangent | (×10⁻⁶/° C.) | (W/mK) | Notes |
| Boron | 4892° F. | 4.1-4.6 | 1.4 × 10⁻³ | 0.6 to −0.46 | 71-171 | Hexagonal |
| Nitride | (2700° C.) | | | | | form is |
| (BN) | (reducing) | | | | | machinable |
| | 1562° F. | | | | | ‘white |
| | (~850° C.) | | | | | graphite’ |
| | (oxidising) | | | | | |
| Synthetic | ~3272° F. | 9.4(O) | 3.0 − | 9.0 | 40 | Negative |
| Sapphire | (~1800° C.) | 11.6 (E) | 8.6 × 10⁻⁵ | (1000° C.) | | uniaxial |
| (Al₂O₃) | melts at | | | | | crystal |
| | 3722° F. | | | | | |
| | (2050° C.) | | | | | |
| Fused | Annealing | 3.82 | 2 × 10⁻⁵ | 0.55 | 1.38 | Non- |
| silica | point 2084° F. | | | | | crystalline |
| (SiO₂) | (1140° C.) | | | | | form of |
| | | | | | | quartz |
| Macor | 1472° F. | 5.67 | 7.1 × 10⁻³ | 12.6 | 1.5 | Machinable |
| | (800° C.) | | | | | glass |
| | continuous, | | | | | ceramic |
| | 1832° F. | | | | | |
| | (1000° C.) | | | | | |
| | peak | | | | | |
| Quartzel | 2822° F. | 1.13 | 0.0036 | | | Quartz |
| rigid | (1550° C.) | | | | | fibres with |
| silica | | | | | | mineral |
| | | | | | | binder |

In some exemplary embodiments of the present invention, synthetic sapphire is used as one of the dielectric materials within the sensor 10. Sapphire is useful in a harsh environment such as those envisaged in the present application, owing to its high mechanical strength, high temperature stability, good wear resistance and chemical inertness. For small items, as is required in this case, the cost is relatively low.

Sapphire is a uniaxial crystal whose dielectric constant depends on the polarisation state of the wave. It is therefore required to be oriented correctly in the sensor to obtain the effective dielectric constant needed in the design. Its loss tangent is considered to be sufficiently low at 12 GHz.

Boron nitride is another suitable dielectric which has the following properties:
High thermal conductivity
Low thermal expansion
Good thermal shock resistance
High electrical resistance
Low dielectric constant and loss tangent
Microwave transparency
Non toxic
Easily machined—non abrasive and lubricious
Chemically inert
Not wet by most molten metals

Boron nitride is often referred to as “white graphite” because it is a lubricious material with the same plate hexagonal structure as carbon graphite. But, unlike graphite, boron nitride is a very good electrical insulator. It offers very high thermal conductivity and good thermal shock resistance. Boron nitride is stable in inert and reducing atmospheres up to 5080° F. (2800° C.), and in oxidising atmospheres to 1560° F. (850° C.).

Three grades are commonly used, including a boric oxide binder system, a calcium borate binder system, and a pure diffusion bonded grade.

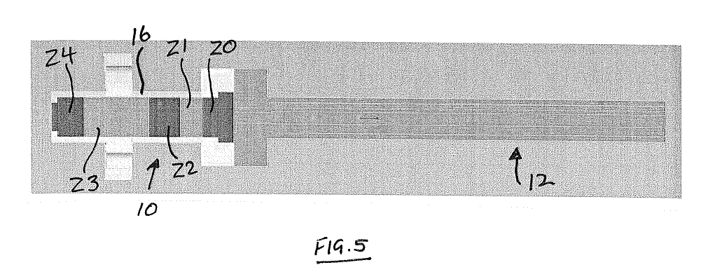

Referring to FIG. 4 of the drawings, a sensor according to a first exemplary embodiment of the present invention comprises a dielectric-loaded circular waveguide of radius 5.6 mm, designed to give a return loss of 20 dB over a 1 GHz band centred on 12 GHz. The first section of dielectric comprises an outer “window” Z7 of synthetic sapphire, having a dielectric constant approximating the mean permittivity ∈_{R} of 10 and a thickness of 0.5 mm. The waveguide is impedance matched with sections of fused silica (∈_{R}=3.8) Z6, Z4, Z2, Z0 interspersed with air gaps (∈_{R}=1) Z5, Z3, Z1. The dielectric constant required for the window Z7 is dictated by the required operating frequency of the sensor, and can be achieved by suitable orientation of the optic axis of the crystalline sapphire. The dimensions of the matching dielectric sections Z6-Z0 are selected to minimise the impedance differences at each interface so as to maximise the power transfer through the sensor, according to known techniques, and are shown in the table below:

| Section | Dielectric Constant | Length (mm) |
|---|---|---|
| Z0 | 3.8 | — (arbitrary) |
| Z1 | 1.0 | 1.987 |
| Z2 | 3.8 | 3.458 |
| Z3 | 1.0 | 4.981 |
| Z4 | 3.8 | 3.176 |
| Z5 | 1.0 | 5.979 |
| Z6 | 3.8 | 0.093 |
| Z6 | 10.0 | 0.500 (R = 5.2 mm) |

The outer casing 14 will also be exposed to extreme temperatures in the turbine. The sensor is intended to be mounted to the turbine wall which, even after cooling, exceeds 1300° F. (700° C.). Thus, the material for the outer casing also needs to be carefully selected to ensure that it can withstand the high temperature environment. The table shown below illustrates the key properties of some exemplary suitable materials that can be used in a sensor according to embodiments of the invention:

| | | | Thermal | | | |
|---|---|---|---|---|---|---|
| | Melting | | Conductivity | CTE | Worka- | |
| Material | Temperature | | (W/m-C.) | (m/m-C.) | bility | Welding |
| Titanium | 2800° | F. | 17 | 1.01E−5 | fair | hard |
| 6al-4v | (1538° | C.) | | | | |
| Nickel | 2540° | F. | 35.3 | 1.62E−5 | Hard | Hard |
| Alloy x- | (1393° | C.) | | | | |
| 750 | | | | | | |
| Stainless | 2250° | F. | 16.3 | 1.89E−5 | Fair/ | fair |
| steel | (1230° | C.) | | | hard | |
| Platinum | 3215° | F. | 73 | 0.8E−5 | — | — |
| | (1768° | C.) | | | | |

The temperature at which the materials maintain useful mechanical properties will be somewhat lower than the melting temperature. For example, platinum is structurally sound up to 2550° F. (1400° C.) and, therefore, is a good candidate for the casing around the tip of the sensor. CMSX4 is another material used in aerospace engineering that is known to be structurally sound to 2100° F. (1150° C.). Titanium has the lowest coefficient of thermal expansion, but is relatively difficult to weld. A range of materials have been considered by the inventors for the manufacture of the waveguide. Stainless steel has advantages as it is machinable and will not melt at 1300° F. (700° C.). It is also cheaper to purchase than, for example, titanium, but stainless steel does have a higher thermal expansion coefficient. It is thought that some coaxial connections exist that can withstand the required temperatures, thus enabling the waveguide to be eliminated from the design altogether.

The resultant sensor, as described above, is suitable for use at high temperatures, but may not be suitable for use at the highest turbine temperatures, because of the air gaps and relatively thin sapphire window. Furthermore, in the confined space available within the engine, it is advantageous to reduce the dimensions of the sensor as much as possible. In order to reduce the overall diameter of the sensor, the internal matching sections are, once again, loaded with dielectric having a high permittivity. Therefore, two exemplary embodiments of a high temperature monostatic antenna are proposed, and shown in the tables below.

| | | |
|---|---|---|
| Section | Dielectric Constant | Length (mm) |

Design 1

| | | |
|---|---|---|
| Z0 | 10.0 | Arbitrary |
| Z1 | 3.8 | 3.88 |
| Z2 | 10.0 | 6.24 |
| Z3 | 3.8 | 9.76 |
| Z4 | 10.0 | 6.17 |

Design 2

| | | |
|---|---|---|
| Z0 | 10.0 | Arbitrary |
| Z1 | 4.1 | 4.15 |
| Z2 | 10.0 | 5.98 |
| Z3 | 4.1 | 12.55 |
| Z4 | 10.0 | 5.99 |

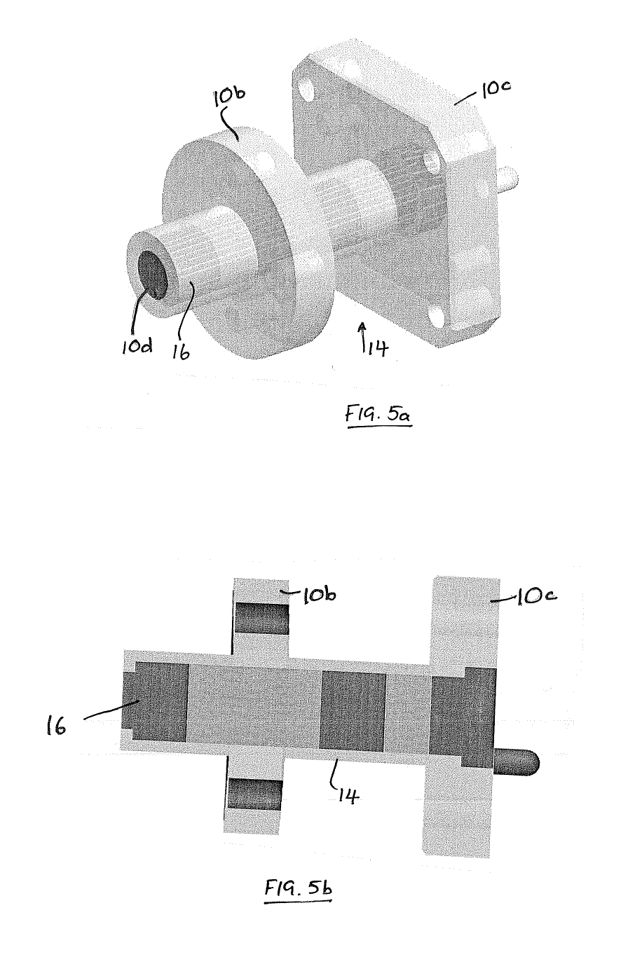

Thus, referring to FIG. 5 of the drawings, the proposed high temperature monostatic antenna has five sections Z0-Z4. The radiating aperture section or “window” Z4 may be formed of a 6.17 mm layer of sapphire having a permittivity of 10. In this case, sections Z3 and Z1 may be formed of fused silica, having a permittivity of 3.8 and sections Z2 and Z0 may again be formed of sapphire. In an alternative exemplary embodiment, section Z4 may be formed of a 5.99 mm layer of sapphire, and sections Z3 and Z1 being formed of boron nitride. Thus, only two silica or boron nitride sections are used to match the proposed antennas, keeping the overall length as short as possible.

Referring to FIG. 5a of the drawings, the casing 10a provides a means to contain the dielectric material, attachment to the engine and attachment of the waveguide. The casing, in this exemplary embodiment, is cylindrical in section, with a lip 10d preventing the dielectric material 16 from falling into the engine at one end and a waveguide attached to the casing to contain it at the opposite end. A flange 10b is provided at the front to attach the sensor to the turbine and another flange 10c is provided at the rear to attach a waveguide. Ideally, the expansion coefficients of the dielectrics and casing would be substantially matched to prevent gaps arising at high temperatures, which would cause the sensor to rattle and become damaged under vibration. It is thought that a high melting potting compound could be used to hold the dielectric materials in place.

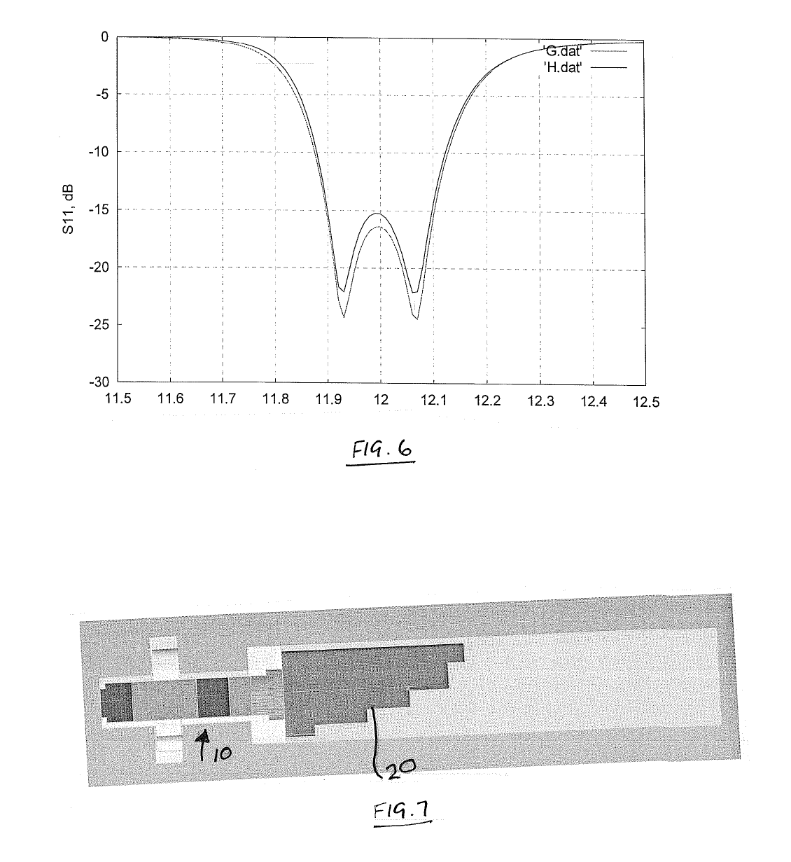

Referring to FIG. 6 of the drawings, it can be seen that the operating bandwidth of the resultant antennas is about 1 GHz, centred in this case, around a 12 GHz operating frequency. A double ridged waveguide may be used to connect the antenna and the transmitter/receiver unit.

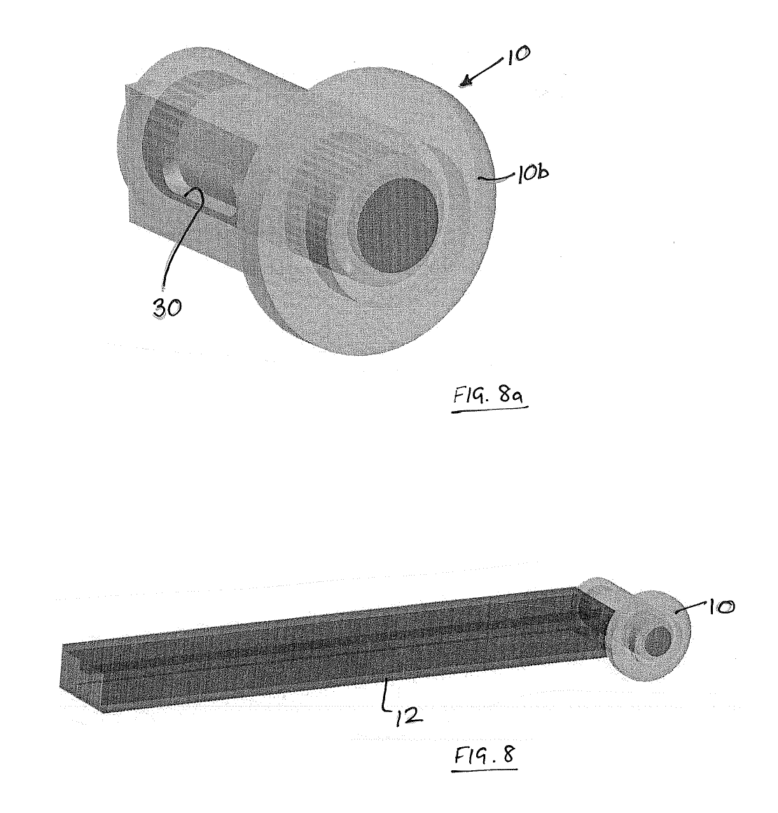

Referring to FIG. 7 of the drawings, the sensor designs described above may also be used in a high temperature bistatic antenna. In this case, a dual-polarised sensor is provided with one port dedicated to transmission and one to reception. Thus, the antenna shown in FIG. 7 is similar in many respects to that shown in and described with reference to FIG. 5, except that it has two circularly-polarised input ports. A septum polariser 20 may be used to enable the two circularly polarised modes to be launched. The two inputs may comprise a pair of rectangular waveguides with a common broad wall. It can be seen from FIG. 7 that in the septum polariser section, the common wall steps away to form a waveguide of substantially square cross-section.

Referring to FIGS. 8 and 8a of the drawings, in yet another exemplary embodiment of the present invention, the waveguide 12 may be rotated through 90 degrees and coupled to the side wall of the circular sensor 10 by means of a longitudinal slot. The internal structure of the sensor 10 may be similar to that described with reference to FIG. 7 above, although in this case, the dielectric materials may comprise sapphire and quartz. The casing is provided with a concentric flange 10b to enable the sensor 10 to be welded to the engine. The advantage of this proposed design is that the overall height of the structure is reduced, thereby enabling it to be accommodated inside the 20 mm cooling duct around the turbine casing of a turbine assembly.

It is thought that the waveguide 12, in all cases, will need to be several meters long before it, and the environment, are cool enough for coaxial connection cables to be employed, bearing in mind that conventional coaxial cable contains PTFE which melts at around 580° F. (300° C.). A double ridged waveguide or dual waveguide structure is envisaged, depending on whether the sensor is monostatic or bistatic respectively. Any of the high temperature metal materials referred to in the table above may be used to form the waveguide, although a dual waveguide would require welding, and nickel alloy and titanium are difficult to weld.

It will be appreciated by a person skilled in the art that modifications and variations can be made to the described embodiments without departing from the scope of the invention as claimed.

What is claimed is:

1. A dielectric loaded antenna for use in a high temperature environment, the antenna comprising an outer casing of a material having a melting point of at least 1000° C., said outer casing defining an inner channel, a first end of the channel defined by the casing defining a radiating aperture loaded with a section of dielectric material of a first type which is chemically stable at a temperature of at least 1500° C., and a remaining length of said channel being loaded with sections of at least one second type of dielectric material which is chemically stable at a temperature of at least 800° C., wherein the dielectric constant of said first type of dielectric material is greater than that of the second type of dielectric material, and wherein the respective interfaces between adjacent sections of dielectric material are impedance matched.

2. The dielectric loaded antenna according to claim 1, wherein said material of said outer casing comprises one or more of titanium, nickel alloy, stainless steel, and platinum.

3. The dielectric loaded antenna according to claim 1, wherein said first type of dielectric material comprises synthetic sapphire.

4. The dielectric loaded antenna according to claim 1, wherein said first and second types of dielectric materials are selected from boron nitride, synthetic sapphire, fused silica, macor and quartzel rigid silica.

5. The dielectric loaded antenna according to claim 1, wherein said second type of dielectric material comprises fused silica.

6. The dielectric loaded antenna according to claim 1, wherein said second type of dielectric material comprises boron nitride.

7. The dielectric loaded antenna according to claim 1, wherein said second type of dielectric material comprises quartz.

8. The dielectric loaded antenna according to claim 1, comprising a plurality of alternating sections of said first and second types of dielectric material, each section adjoining the next to substantially prevent spaces therebetween.

9. The dielectric loaded antenna according to claim 1, wherein said outer casing is substantially cylindrical and said channel comprises a generally central bore through its axial length.

10. A sensor for use in a high temperature environment, comprising an antenna according to claim 1, and a waveguide coupled to said channel.

11. The sensor according to claim 10, wherein said waveguide is coupled to a second end of said channel.

12. The sensor according to claim 10, wherein said waveguide is coupled to said channel via a longitudinal slot provided in a side wall of said outer casing.

13. A method of manufacturing a dielectric loaded antenna for use in a high temperature environment, the method comprising the steps of providing an outer casing of a material having a melting point of at least 1000° C., said outer casing defining a channel, loading a first end of said channel with a section of dielectric material of a first type which is chemically stable at a temperature of at least 1500° C., impedance matching a remaining length of said channel by inserting therein sections of at least one second type of dielectric material which is chemically stable at a temperature of at least 800° C. and impedance matching respective interfaces between adjacent sections of dielectric material, wherein the dielectric constant of said first type of dielectric material is greater than that of said second type of dielectric material.

14. The method according to claim 13, wherein said material of said outer casing comprises one or more of titanium, nickel alloy, stainless steel, and platinum.

15. The method according to claim 13, wherein said first and second types of dielectric material are selected from boron nitride, synthetic sapphire, fused silica, macor and quartzel rigid silica.
